(19) United States
(12) Patent Application Publication
(10) Pub. No.: US 2024/0057228 A1
(43) Pub. Date: Feb. 15, 2024

(54) COOKING APPLIANCE

(71) Applicant: LG ELECTRONICS INC., Seoul (KR)

(72) Inventors: Junghyeong HA, Seoul (KR); Sunghun SIM, Seoul (KR); Yunbyung CHAE, Seoul (KR)

(73) Assignee: LG ELECTRONICS INC., Seoul (KR)

(21) Appl. No.: 18/266,925

(22) PCT Filed: Jan. 12, 2021
(86) PCT No.: PCT/KR2021/000401

§ 371 Date: Jun. 13, 2023

(30) Foreign Application Priority Data
Dec. 31, 2020 (KR) 10-2020-0189865

(51) Int. Cl. H05B 6/64; H05B 6/12

(52) U.S. Cl. CPC H05B 6/6488; H05B 6/1209

(57) ABSTRACT

The cooking appliance has a casing having an open front, a cooking space formed therein and an opening part formed at one side thereof, a microwave generator for generating and directing a microwave toward the cooking space; an induction coil facing the opening part, the cooking part being arranged outside the space; and a shielding plate arranged between the induction coil and the opening part. The shielding plate includes an insulator; a first pattern, which is formed on one surface of the insulator and faces the opening part, and a second pattern, which is formed on the other surface of the insulator and is perpendicular to the first pattern. The first pattern has a slit formed in a region facing the opening part.

### CROSS-REFERENCE TO RELATED APPLICATIONS

This application is the National Phase of PCT International Application No. PCT/KR2021/000401, filed on Jan. 12, 2021, which claims priority under 35 U.S.C. § 119(a) to Patent Application No. 10-2020-0189865, filed in the Republic of Korea on Dec. 31, 2020, all of which are hereby expressly incorporated by reference into the present application.

### TECHNICAL FIELD

The present invention relates to a cooking appliance, and more particularly, to a cooking appliance having an induction coil.

### BACKGROUND ART

As a device for cooking food, etc. (hereinafter referred to as food), it can be classified into a closed type cooking device and an open type cooking device according to the shape of a space in which food is placed.

The closed type cooking device cooks food in a state in which a cooking space is shielded, such as ovens and microwave ovens,

The open type cooking device cooks food in an open space, such as a cooktop.

A microwave oven is a cooking device that uses microwaves to heat and cook food to be cooked using microwaves, molecules constituting food vibrate with microwaves, and as a result, the temperature of food rises due to frictional heat generated between the constituent molecules. do. This heating method is called dielectric heating method.

Recently, in addition to the heating method by microwaves, there is an induction heating and cooking combined microwave oven equipped with an induction coil as a separate heating means and capable of cooking food in a cavity by induction heating via the induction coil.

The microwave oven using induction heating and cooking requires a shielding structure that prevents microwaves from penetrating into the induction coil.

An example of a cooking appliance capable of protecting an induction coil by installing a shielding plate for shielding electromagnetic waves penetrating into an induction coil inside the cooking appliance is a microwave oven for both induction heating and cooking disclosed in Korean Registered Patent Publication No. 10-0176773 B1 (published on May 15, 1999).

The induction heating and cooking combined microwave oven comprises a working coil generating an induced current; and the shielding plate, the shielding plate comprises a first metal wire portion in which a plurality of metal wires are arranged parallel to each other, and a second metal wire portion in which a plurality of metal wires are arranged parallel to each other so as to be spaced apart from the first metal wire portion at a predetermined interval and face each other at a predetermined angle and the shielding plate comprises an insulating material interposed between the first metal wire portion and the second metal wire portion.

### DISCLOSURE

### Technical Problem

The shielding plate according to the prior art has a problem in that when the first metal wire portion contacts the casing, the first metal wire portion can become an eddy current passage of induction, and the shielding plate is heated and damaged. In addition, there is a problem in that the heating efficiency is lowered because the magnetic field does not pass through the shielding plate.

An object of the present invention is to provide a cooking appliance in which a shielding plate does not become an eddy current passage for induction and the heating efficiency of an induction coil is high.

### Technical Solution

The cooking appliance according to the present embodiment comprises a casing having an open front, having a cooking space formed therein and having an opening formed at one side thereof; a microwave generator for generating a microwave toward the cooking space; an induction coil facing the opening, and arranged outside the casing for induction heating; and a shielding plate arranged between the induction coil and the opening. The shielding plate comprises an insulator; a first pattern formed on one surface of the insulator and facing an opening; and a second pattern formed on the other surface of the insulator and perpendicular to the first pattern.

One example of the first pattern has a slit formed in a region facing the opening.

Eddy current formation can be prevented by the slit, and the first pattern does not function as an eddy current path.

The shielding plate is larger than the opening, and a peripheral portion of the shielding plate contacts a periphery of the opening.

The first pattern comprises a plurality of metal wire lines parallel.

Each of the plurality of parallel metal wire lines respectively comprise an opening facing portion facing the opening; and a casing contact portion contacting the casing.

The slit is a formed in the opening facing portion.

The slit having a distance of 15 mm or less from a periphery of the opening.

The slit has a length of 0.5 mm or less.

A film or coating is formed disposed on the surface of the shielding plate on which the first pattern is formed, and the film or coating covers the first pattern.

The other example of the cooking appliance further a spacer made of an insulating material is disposed between the opening and the first pattern. The first pattern is spaced apart from a periphery of the opening by the spacer.

Since the first pattern is not in contact with the casing by the spacer, eddy current can be blocked, and leakage of electromagnetic waves between the shielding plate and periphery of the opening can be prevented by the spacer.

A size of the spacer is larger than the opening, and the spacer contacts periphery of the opening part.

A portion of the shielding plate overlaps the casing, and the shielding plate brings the spacer into close contact with periphery of the opening part.

The spacer is a coating layer coated on one surface of the shielding plate.

### Advantageous Effect

According to an embodiment of the present invention, the first pattern does not function as an eddy current passage due to the slits formed in the first pattern, and eddy current is not generated when the induction coil is operated.

Since the spacer is disposed between the first pattern and periphery of the opening part so that the first pattern does not contact the casing, eddy currents can be blocked, and leakage of electromagnetic waves between the shielding plate and periphery of the opening part can be prevented.

### DESCRIPTION OF DRAWINGS

FIG. 1 is a perspective view showing the inside of a cooking appliance according to an embodiment of the present invention;

FIG. 2 is a perspective view partially cut away along line II-II shown in FIG. 1;

FIG. 3 is a cross-sectional view showing an example of a cooking appliance according to an embodiment of the present invention;

FIG. 4 is a top view of the shielding plate shown in FIG. 2;

FIG. 5 is a bottom view of the shielding plate shown in FIG. 2;

FIG. 6 is a modified example of the shielding plate shown in FIG. 3;

FIG. 7 is a cross-sectional view showing another example of a cooking appliance according to an embodiment of the present invention;

FIG. 8 is a top view of the shielding plate shown in FIG. 7; and

FIG. 9 is a bottom view of the shielding plate shown in FIG. 7.

### BEST MODE

Hereinafter, specific embodiments of the present invention will be described in detail with drawings.

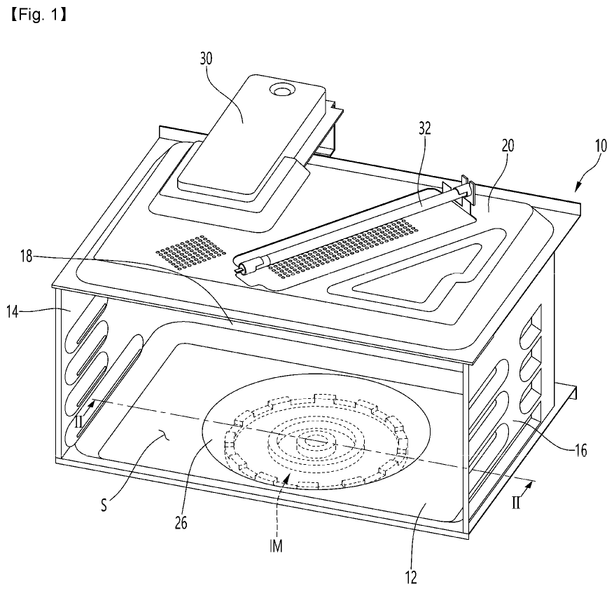

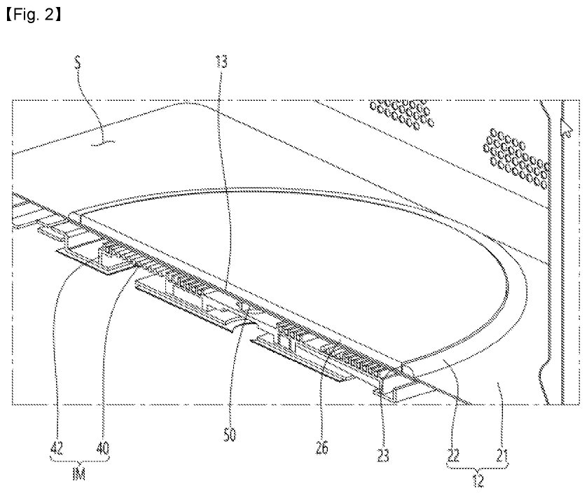

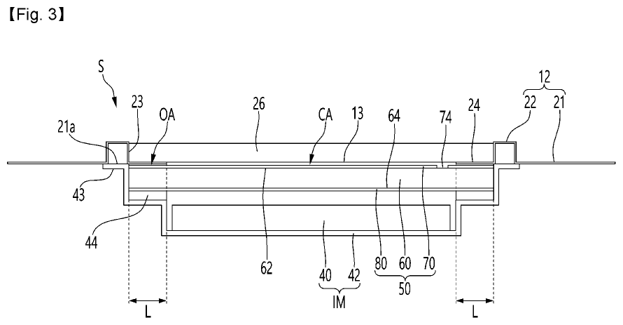

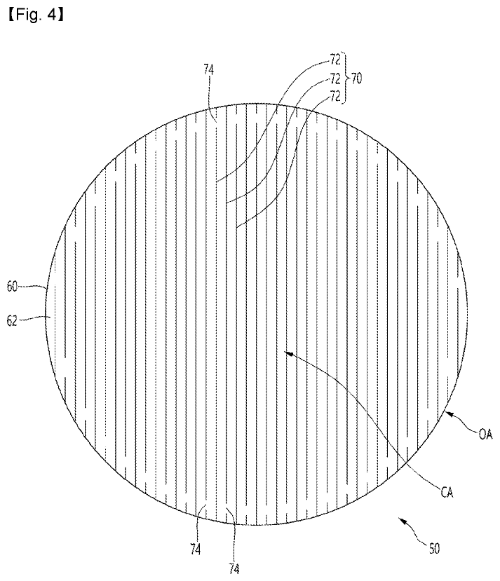

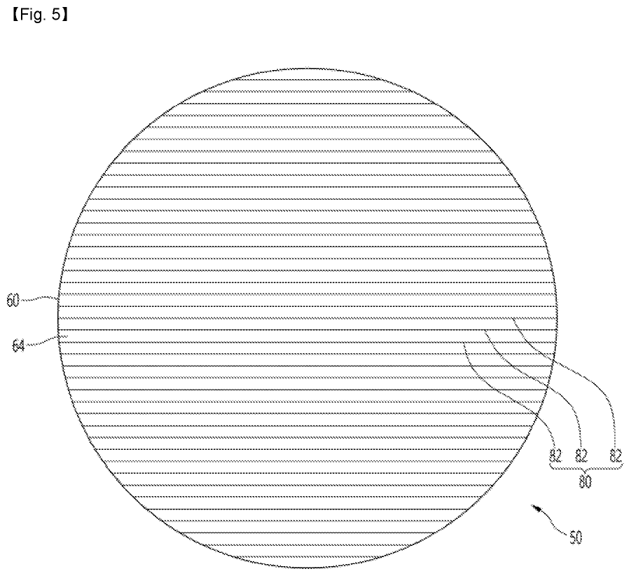

FIG. 1 is a perspective view showing the inside of a cooking appliance according to an embodiment of the present invention; FIG. 2 is a perspective view partially cut away along line II-II shown in FIG. 1; FIG. 3 is a cross-sectional view showing an example of a cooking appliance according to an embodiment of the present invention; FIG. 4 is a top view of the shielding plate shown in FIG. 2; FIG. 5 is a bottom view of the shielding plate shown in FIG. 2.

The cooking appliance according to the present embodiment may comprise a casing 10 in which a cooking space S is formed. The casing 10 may have a three-dimensional shape.

The casing 10 comprises the lower wall 12, a pair of side walls 14 and 16 disposed above the lower wall 12, and the back wall 18, and the lower wall 12 in an upward and downward direction. A spaced upper wall 20 may be comprised.

The front of the casing 10 may be open, and the cooking space S may be formed inside the casing 10. An example of the material of the casing 10, particularly the lower wall 12, may be SUS403.

An opening 13 may be formed on one side of the casing 10. The opening 13 may be formed in one of the lower wall 12, the pair of side walls 14 and 16, the back wall 18, and the upper wall 20.

The lower wall 12 may comprise a lower body 21 in which a hole 21a larger than the opening 13 (see FIG. 3) is formed, and a forming body 22 forming the opening 13.

The lower body 21 and the forming body 22 may be integrally formed, or may be formed as separate bodies and coupled to each other.

A forming space 23 may be formed inside the forming body 22, and an opening 13 may be formed at a lower side of the forming space 23. The opening 13 may be smaller in size than the forming space 23.

A periphery 24 of the opening may be formed in the forming body 22. The periphery 24 of the opening may protrude from the lower end of the inner wall forming the forming space 23.

A glass 26 may be disposed in the forming space 23 to prevent foreign substances such as food from penetrating into the shielding plate 40. The forming body 22 may be disposed to surround the outer circumference of the glass 26. One example of glass 26 may be heat-resistant glass.

The glass 26 may be formed larger than the opening 13. The glass 26 may be seated on a periphery 24 of the opening.

The glass 26 may be bonded to casing 10 using a sealant.

The cooking appliance may further comprise a microwave generator (30, see FIG. 1) generating microwaves into the cooking space (S). The cooking appliance may further comprise a heater 32 (see FIG. 1) for heating the cooking space S. A microwave generator 30 and a heater 32 may be disposed in the casing 10.

An example of the microwave generator 30 may comprise a magnetron for generating electromagnetic waves, a waveguide for connecting the magnetron and the casing, and introducing electromagnetic waves into the cooking space S, and an agitator such as a stirrer fan rotating for uniform heating.

At least one heater 32 may be installed in the casing 10.

The cooking appliance may further include an induction coil 40 (see FIG. 2) for induction heating, and a shielding plate 50 (see FIGS. 2 and 3) disposed between the induction coil 40 and the opening 13.

The induction coil 40 is a 20-70 kHz band induction working coil located outside the cooking space S, so that the casing 10 is not heated, and the container containing the food located in the cooking space S can be heated.

The induction coil 40 may be spaced apart from the microwave generator 30 and the heater 32. When the microwave generator 30 and the heater 32 are disposed above the casing 10, the induction coil 40 may be disposed below the casing 10.

The cooking appliance may further comprise a bracket 42 supporting the induction coil 40.

The induction coil 40 may be disposed above the bracket 42, and the induction coil 40 and the bracket 42 may constitute an induction module IM.

The induction coil 40 may be disposed outside the casing 10 toward the opening 13. The size of the induction coil 40 may be smaller than the size of the opening 13.

The bracket 42 may be larger than the opening 13. The bracket 42 may be coupled to the lower wall 12. The bracket 42 may comprise a fastening part 43 coupled to the lower wall 12 with a fastening member such as a screw.

A shielding plate holder 44 (see FIG. 3) made of non-metal and pressing the shielding plate 50 upward may be disposed on the bracket 42.

The shielding plate holder 44 may be disposed between the bracket 42 and the shielding plate 50, and is placed on the bottom of the shielding plate 50 so that the shielding plate 50 is in close contact with the lower surface of the lower wall 12.

The shielding plate holder 44 may have a ring shape.

The shielding plate 50 is in close contact with the casing 10 from the outside of the cooking space S, and can block sparks caused by the discontinuous surface of the edges.

As shown in FIGS. 3 to 5, the shielding plate 50 may include an insulator 60, a first pattern 70 and a second pattern 80.

The insulator 60 may insulate the first pattern 70 and the second pattern 80 between the first pattern 70 and the second pattern 80.

Examples of the first pattern 70 and the second pattern 80 may be alumina-based and may be formed by an etching process.

The first pattern 70 and the second pattern 80 may be copper wires or non-magnetic stainless wires.

The first pattern 70 may be formed on one surface 62 of the insulator 60. As shown in FIG. 3, the first pattern 70 may face the opening 13.

The second pattern 80 may be formed on the other surface 64 of the insulator 60. The second pattern 80 may be spaced apart from the first pattern 70 and may be formed on a surface opposite to the surface of the insulator 60 on which the first pattern 70 is formed.

As shown in FIGS. 4 and 5, the second pattern 80 may be perpendicular to the first pattern 70. The first pattern 70 and the second pattern 80 may selectively shield electromagnetic waves. For example, in the electromagnetic wave generated by the microwave generator 30, the horizontal polarization of the horizontal polarization and the vertical polarization is removed by the first pattern 70, and the vertical polarization transmitted through the first pattern 70 is removed by the second pattern 80. As another example, in the electromagnetic wave generated by the microwave generator 30, the vertical polarization of the horizontal polarization and the vertical polarization is removed by the first pattern 70, and the horizontal polarization transmitted through the first pattern 70 is removed by the second pattern 80.

The shielding plate 50 may be horizontally disposed below the lower wall 12. One surface 62 of the insulator 60 may be an upper surface of the insulator 60, and the other surface 64 of the insulator 60 may be a lower surface of the insulator 60.

The first pattern 70 may be an upper pattern or upper filter formed on the upper surface 62 of the insulator 60, and the second pattern 80 may be a lower pattern or lower filter formed below the lower surface 62 of the insulator 60.

As shown in FIG. 4, the first pattern 70 may be composed of a plurality of metal wire lines 72 parallel to each other, hereinafter referred to as a plurality of first metal wire lines. The first pattern 70 may be composed of a combination of a plurality of first metal wire lines 72.

As shown in FIG. 5, the second pattern 80 may be composed of a plurality of metal wire lines 82 parallel to each other, and hereinafter referred to as a plurality of second metal wire lines. The second pattern 80 may be composed of a combination of a plurality of second metal wire lines 82.

Each of the first metal line 72 and the second metal line 82 may be formed in a straight-line shape.

The first metal line 72 and the second metal line 82 may be formed in directions perpendicular to each other. For example, when the first metal wire line 72 is formed long in the left and right direction, the second metal wire line 82 may be formed long in the front and rear direction.

The shielding plate 50 can shield electromagnetic waves of 13.56 MHz, 27.12 MHz, 40.68 MHz, 433 MHz, 915 MHz, and 2450 MHz, which are frequencies of the microwave generator 30, by the first metal line 72 and the second metal line 82. and the magnetic field of 20 to 70 kHz, which is the frequency of the induction coil 40, can be transmitted.

The shielding plate 50 may be formed larger than the opening 13. The shielding plate 50 may block the opening 13 at a lower side of the opening 13.

As shown in FIG. 3, the shielding plate 50 may comprise a center portion CA toward the opening 13 in an upward direction, and a peripheral portion OA located around the center portion CA and surrounding the center portion CA.

The center portion CA of the shielding plate 50 may be an opening facing portion located below the opening 13 and facing the opening 13 in an upward direction.

The peripheral portion OA of the shielding plate 50 may be positioned below the periphery 24 of the opening and may face toward the periphery 24 of the opening in an upward direction.

The peripheral portion OA of the shielding plate 50 may contact the periphery 24 of the opening and may be a casing contact portion contacting the casing 10.

The peripheral portion OA of the shielding plate 50 may overlap the periphery 24 of the opening by an overlap length L (see FIG. 3).

The first metal line 72 formed on the upper surface 62 of the shielding plate 50 may also comprise an opening facing portion CA and a periphery facing portion OA (casing contact portion), and a portion of the first metal line 72 may be the opening facing portion, and the rest may be the periphery facing portion.

In the first pattern 70, a slit 74 may be formed in a region facing the opening 13 (i.e., an opening facing portion CA). The slit 74 may be formed in the first metal line 72. The slit 74 may face the opening 13 without facing the periphery 24 of the opening.

If the slit 74 is not formed in the opening facing portion CA and the induction coil 40 is operated, the first metal line 72 of the first pattern 70 contacts the casing 10 and the first metal line 72 of the first pattern 70 may be heated due to the eddy current. That is, the heating efficiency of the vessel by the induction coil 40 may be low.

Since the first metal line 72 of the first pattern 70 is disconnected by the slit 74, eddy current can be minimized and heating efficiency by the magnetic field of the induction coil 40 can be high.

The slit 74 may be located eccentrically in the first metal line 72. The slit 74 may be proximate a periphery 24 of the opening. The slit 74 may be positioned at a distance of less than 15 mm from the periphery 24 of the opening and less than 15 mm from the periphery 24 of the opening.

As shown in FIG. 4, the slits 74 may be formed in all of the first metal line lines 72 having the opening facing portion CA. The length of the slit 74 may be 0.5 mm or less in the length direction of the first metal wire line 72. The first metal line 72 is disconnected by the slit 74, and an eddy current passage through the first metal line 72 can be blocked.

The first metal wire line 72 may be a metal wire line cut by the slit 74.

An example of the first metal wire line 72 may be that the width of the adjacent first metal wire line 72 is 3 mm, the interval between the first metal wire lines 72 is 0.5 mm, and the slit 74 is 0.1 mm.

All of the second metal wire lines 82 formed on the lower surface 64 of the shielding plate 50 may not contact the casing 10 and may be a spaced portion spaced apart from the casing 10.

As shown in FIG. 5, the second metal wire line 78 is spaced apart from the casing 10, so a separate slit 74 does not need to be formed.

As described above, the slit 74 is formed in the first metal line 72 in contact with the periphery 24 of the opening, and the second metal line 82 is formed to be spaced apart from each of the first metal line 72 and the casing 10, eddy current may not be generated when the induction coil 40 operates.

FIG. 6 is a modified example of the shielding plate shown in FIG. 3.

As shown in FIG. 6, the shielding plate 50 may have a film 90 or a coating covering the first pattern 70 is disposed on the surface 62 on which the first pattern 70 is formed. A film 92 or coating covering the second pattern 80 may be disposed on the surface 62 on which the second pattern 80 is formed.

The films 90 and 92 or the coating may protect the first pattern 70 and the second pattern 80.

Since the first pattern 70 and the second pattern 80 can be oxidized as the temperature rises, the insulator 60 has the films 90 and 92 or plating covering the first pattern 70 and the second pattern 80 may be formed.

The films 90 and 92 may be resin films suitable for oxidation prevention.

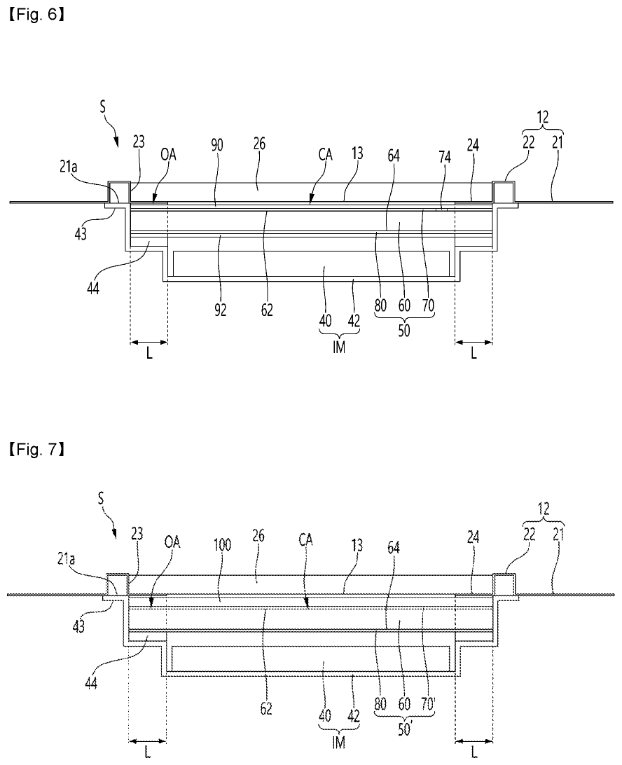

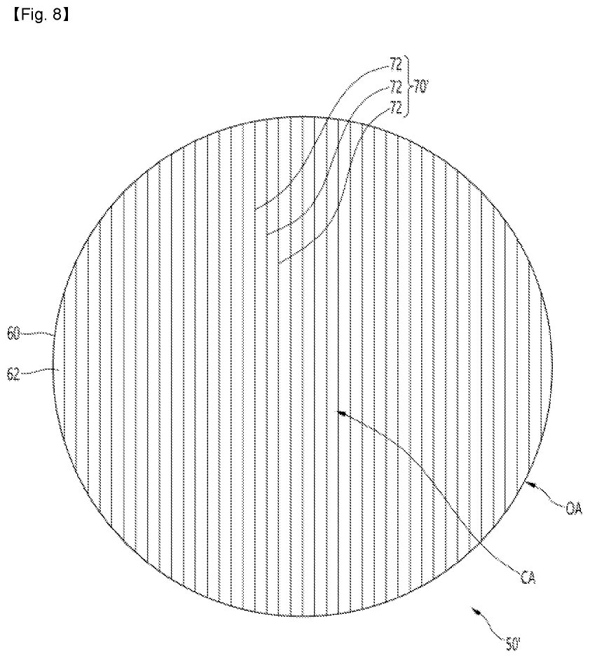

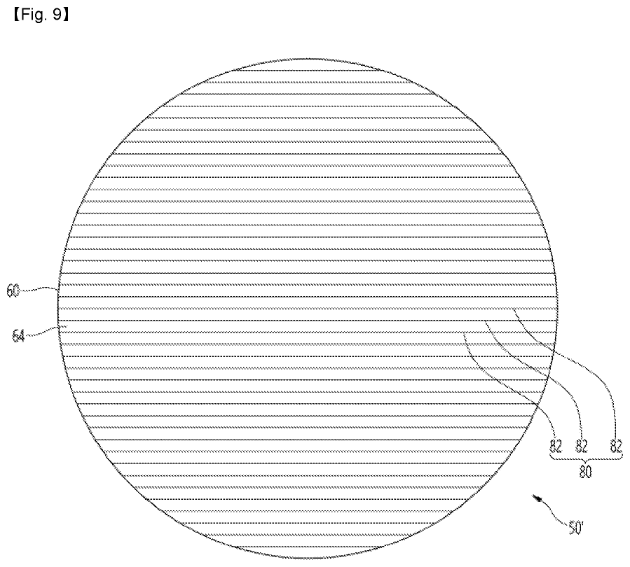

FIG. 7 is a cross-sectional view showing another example of a cooking appliance according to an embodiment of the present invention; FIG. 8 is a top view of the shielding plate shown in FIG. 7; FIG. 9 is a bottom view of the shielding plate shown in FIG. 7.

As shown in FIG. 7, the cooking appliance may comprise a casing 10, a microwave generator 30, an induction coil 40, and a shielding plate 50, and may further include a spacer 100.

The casing 10 may have a front surface open, a cooking space S may be formed therein, and an opening 13 may be formed at one side. Since the casing 10 is the same as or similar to the casing of one example of the cooking appliance, the same reference numeral is used, and a description thereof is omitted to avoid redundant description.

Since the microwave generator 30 can generate microwaves into the cooking space and is the same as or similar to the microwave generator 30 of an example of a cooking appliance, the same reference numerals are used, and description thereof is omitted to avoid redundant description.

The induction coil 40 faces the opening 13 and is disposed outside the casing to perform induction heating. Since the induction coil 40 is the same as or similar to the induction coil 40 of one example of a cooking appliance, the same reference numerals are used and duplicate descriptions are given. To avoid this, the description is omitted.

The shielding plate 50′ is disposed between the induction coil 40 and the opening 13, and may be spaced apart from the casing 10 by the spacer 100.

The shielding plate 50′ is similar to the shielding plate 50 of an example of a cooking appliance in configuration other than the first pattern 70′, and a description thereof is omitted to avoid redundant description.

A portion of the shielding plate 50′ may overlap the casing 10. The shielding plate 50′ may adhere the spacer 100 to the periphery 24 of the opening.

The shielding plate 50′ may comprise an insulator 60, a first pattern 70′, and a second pattern 80.

The configuration of the insulator 60 may be similar to that of the insulator 60 of an example of a cooking appliance, and a detailed description thereof will be omitted to avoid redundant description.

The first pattern 70′ may be formed on one surface of the insulator 60 and face the opening 13. The first pattern 70′ may be spaced apart from the periphery 24 of the opening 13 by the spacer 100. The first pattern 70′ is spaced apart from the casing 10 at a predetermined interval, so that eddy currents can be blocked.

The first pattern 70′ is electrically spaced apart from the periphery 24 of the opening, and a slit 74, like an example of a cooking appliance, may not need in the first metal line 72 constituting the first pattern 70′.

The second pattern 80 is formed on the other surface of the insulator 60, may be perpendicular to the first pattern 70′, may be similar to the second pattern 80 of an example of a cooking appliance, and avoid redundant description. For this reason, a detailed description thereof will be omitted to avoid redundant description.

The spacer 100 may be disposed between the opening 13 and the first pattern 70′, and may be made of an insulating material.

The size of the spacer 100 may be larger than the size of the opening 13. The spacer 100 may contact the periphery 24 of the opening. The spacer 100 may have a central portion facing the opening 13 and a peripheral portion overlapping the periphery 24 of the opening in the vertical direction.

The spacer 100 is interposed between the periphery 24 the opening and the shielding plate 50′ to shield microwaves between the periphery 24 of opening and the shielding plate 50′, and to prevent leakage of the microwaves. The spacer 100 may prevent shielding of microwaves between the glass 26 and the shielding plate 50′.

The spacer 100 may have a maximum thickness of 0.2 mm or less and a minimum thickness of 0.01 mm.

An example of the spacer 100 may be an insulating material made of glass fibers or the like.

The spacer 100 is not limited to a member separate from the shielding plate 50′, and may be a coating layer coated on one surface 62 of the shielding plate 50′.

The above description is merely illustrative of the technical spirit of the present disclosure, and various modifications and changes can be made by those of ordinary skill in the art, without departing from the scope of the present disclosure.

Therefore, the embodiments disclosed in the present disclosure are not intended to limit the technical spirit of the present disclosure, but are intended to explain the technical spirit of the present disclosure. The scope of the technical spirit of the present disclosure is not limited by these embodiments.

The scope of the present disclosure should be interpreted by the appended claims, and all technical ideas within the scope equivalent thereto should be construed as falling within the scope of the present disclosure.

1-11. (canceled)

12. A cooking appliance comprising:
a casing having an open front, the casing defining a cooking space therein, the casing having an opening at one side thereof;
a microwave generator configured to generate and direct a microwave toward the cooking space;
an induction coil facing the opening, the induction coil being located outside the cooking space; and
a shielding plate arranged between the induction coil and the opening, the shielding plate including:
an insulator having a first surface facing the opening and a second surface opposite the first surface;
a first pattern on the first surface of the insulator, the first pattern having a slit in a region facing the opening; and
a second pattern on the second surface of the insulator, the second pattern being arranged perpendicular to the first pattern.

13. The cooking appliance of claim 12, wherein the shielding plate is larger than the opening such that a peripheral portion of the shielding plate contacts a periphery of the opening.

14. The cooking appliance of claim 12, wherein the first pattern comprises a plurality of parallel metal wire lines, each of the plurality of parallel metal wire lines including:
a first portion facing the opening; and
a second portion contacting the casing.

15. The cooking appliance of claim 14, wherein the slit is provided in the first portion.

16. The cooking appliance of claim 15, wherein the slit is located in the first pattern at a distance of 15 mm or less from a periphery of the opening.

17. The cooking appliance of claim 16, wherein the slit has a length of 0.5 mm or less.

18. The cooking appliance of claim 16, further comprising a film or coating on the first surface of the insulator to cover the first pattern.

19. The cooking appliance of claim 12, wherein the first pattern comprises a plurality of parallel metal wire lines, and wherein the slit is located in the first pattern at a distance of 15 mm or less from a periphery of the opening.

20. The cooking appliance of claim 19, wherein the slit has a length of 0.5 mm or less.

21. The cooking appliance of claim 20, further comprising a first film or coating on the first surface of the insulator to cover the first pattern.

22. The cooking appliance of claim 21, further comprising a second film or coating on the second surface of the insulator to cover the second pattern.

23. The cooking appliance of claim 12, further comprising a first film or coating on the first surface of the insulator to cover the first pattern.

24. The cooking appliance of claim 12, wherein the second pattern comprise a plurality of parallel metal wire lines.

25. The cooking appliance of claim 24, wherein the plurality of parallel metal wire lines of the second pattern extend uninterrupted across the second surface of the insulator.

26. A cooking appliance comprising:
a casing having an open front, the casing defining a cooking space therein, the casing having an opening at one side thereof, a microwave generator configured to generate and direct a microwave toward the cooking space;
an induction coil facing the opening, the induction coil being located outside the cooking space;
a shielding plate arranged between the induction coil and the opening, the shielding plate including:
an insulator having a first surface facing the opening and a second surface opposite the first surface;
a first pattern on the first surface of the insulator; and
a second pattern on the second surface of the insulator, the second pattern being arranged perpendicular to the first pattern; and
a spacer made of an insulating material located between the opening and the first pattern such that the first pattern is spaced apart from a periphery of the opening.

27. The cooking appliance of claim 26, wherein a size of the spacer is larger than the opening such that the spacer contacts the periphery of the opening.

28. The cooking appliance of claim 26, wherein a portion of the shielding plate overlaps the casing, and wherein the shielding plate supports the spacer.

29. The cooking appliance of claim 26, wherein the spacer is a coating layer on the first surface of the insulator.

30. The cooking appliance of claim 26, wherein the first pattern comprises a plurality of parallel metal wire lines, and wherein the second pattern comprise a plurality of parallel metal wire lines.

31. The cooking appliance of claim 30, wherein the plurality of parallel metal wire lines of the second pattern extend uninterrupted across the second surface of the insulator.
